(19) United States
(12) Patent Application Publication
(10) Pub. No.: US 2013/0085865 A1
(43) Pub. Date: Apr. 4, 2013

(54) CONTEXT-CONTINGENT TARGETING IN ONLINE ADVERTISING

(71) Applicants: Yang Zhou, Santa Clara, CA (US); Ruofei Zhang, Mountain View, CA (US)

(72) Inventors: Yang Zhou, Santa Clara, CA (US); Ruofei Zhang, Mountain View, CA (US)

(73) Assignee: Yahoo! Inc., Sunnyvale, CA (US)

(21) Appl. No.: 13/252,382

(22) Filed: Oct. 4, 2011

(51) Int. Cl. G06Q 30/02

(52) U.S. Cl. 705/14.66

(57) ABSTRACT

An advertising exchange server for context-contingent targeting of online advertisements may include a processor, memory, a communication interface, and a database saved in system storage to store advertisements saved in relation to advertising attributes. The processor may be configured to work with the communication interface to provide an option for an advertiser to express a targeting profile using a freeform mixture of logical operations including a plurality of targeting attributes, the freeform mixture of logical operations excluding solely a series of conjunctive combinations. The processor may receive, and store in memory, the expressed targeting profile and at least one associated advertisement from the advertiser. The processor may receive and match an advertising opportunity with one or more targeting attributes of the targeting profile. The processor may deliver the advertisement associated with the targeting profile that substantially matches the advertising opportunity to fill the advertising opportunity.

### BACKGROUND

The disclosed embodiments relate to systems and methods for executing context-contingent targeting of online advertisements, and more particularly, to executing context-contingent targeting based on multiple targeting attributes combined with a freeform of logical operations.

An objective in online advertising is to deliver advertisements (ads) to the intended online users, e.g., make-up to women in North America or a restaurant in New York City to New Yorkers. Advertisers develop targeting profiles, expressed or characterized by a set of targeting attributes, to specify the intended online users and desired publisher criteria. When an online user visits a web site and generates an advertising opportunity, an ad exchange of an ad network matches the information of the user to the targeting attributes of a collection of ads. The ad exchange selects the eligible ads that match targeting profiles to enter the auction process, and an ad is selected to display on the webpage as one impression, based on the auction results. The user may respond to the ad, which leads to a click and/or a conversion.

The targeting attributes of an ad, therefore, play a seminal role in whether a particular ad is selected to be displayed in response to a specific advertising opportunity. Inaccurately-specified targeting attributes may result in a less-relevant user pool and thus hurt the efficacy of the matching executed by the ad exchange. Current targeting attributes are combined logically in a conjunctive form such that the specification of each targeting type is independent from others.

### BRIEF DESCRIPTION OF THE DRAWINGS

The system may be better understood with reference to the following drawings and description. The components in the figures are not necessarily to scale, emphasis instead being placed upon illustrating principles. In the figures, like referenced numerals may refer to like parts throughout the different figures unless otherwise specified.

FIG. 1 is a diagram of an exemplary system for executing context-contingent targeting of online advertisements.

FIG. 2 is a diagram of an exemplary system diagram of architecture of the ad exchange server of FIG. 1.

FIG. 3 is an exchange graph diagram showing the classic “flat” ad matching problem.

FIG. 4 is an exchange graph diagram showing an ad matching problem that includes intermediate ad-network entities.

FIG. 5 is a flow chart of an exemplary method for executing context-contingent targeting of online advertising with the system of FIGS. 1 and 2.

FIG. 6 illustrates a general computer system, which may represent any of the computing devices referenced herein.

### DETAILED DESCRIPTION

A targeting type includes an existing attribute type. Examples of targeting types include age, gender, country, frequency-capping and the like. A targeting entity of a targeting type includes one or a list of values that this targeting type can include or exclude. A targeting attribute includes a pair of a targeting type (other than a “segment”) and a targeting entity, and a relationship that may be to “include” or to “exclude.” A targeting attribute can be expressed as “type ∈ (entity list)” or “type ∉ (entity list).” When the entity list has only one element, the targeting attribute can be expressed as “type=entity” or “type≅entity,” The above expressions can be written in Boolean form: “type≅entity” can be expressed as “ [symbol] (type=entity),” “type ∈ (entity list)” can be expressed as “(type=entity₁) [symbol] . . . [symbol] (type=entity_{N}),” and “type ∉ (entity list)” can be expressed as “ [symbol] (type=entity₁) [symbol] . . . [symbol] [symbol] (type=entity_{N}).” For targeting type of “segment,” the targeting attribute may be expressed as a Conjunctive Normal Form (CNF) or Disjunctive Normal Form (DNF). The targeting profile may include a mixture of user attributes (such as age, income, geographic location and the like) and publisher attributes (such as on a page related to hunting or golf, position on the page, time of day and the like).

A targeting profile of an online advertising campaign includes a set of targeting attributes. These targeting attributes are combined logically using AND or OR operators. In the traditional targeting profiles, advertisers first express the targeting attribute, specifying each targeting type may include or exclude some values, then these targeting attributes are combined by an AND operator to form the targeting profile. In the present disclosure, instead of using this simple form of using the AND operator to combine independent targeting attributes, the targeting attributes can be combined in freeform using any number or combination of logical operations (or operators) based on the dependency or correlation of the targeting attributes. An advantage of this expression is that correlated or dependent targeting attributes can be combined first to form molecular attributes, each of which includes more than one targeting attribute. This is called “context contingent” targeting because the specification of each targeting attribute is contingent upon the specification of some other targeting attributes that form a context. The specification of a targeting attribute takes part in forming this context and is only valid within this context. With context contingent targeting, the specification of targeting attributes becomes much more effective.

More specifically, the current online advertising system uses targeting profiles to specify the intended online users. Each targeting profile includes a set of independently-characterized targeting attributes like age, gender, language, country, region, publisher, channel, time of day, and segments and the like. For each targeting attribute Tᵢ, the advertiser is provided with a set of pre-expressed values Sᵢ. Each targeting attribute Tᵢ may include or exclude any determined values. The targeting profile is evaluated to be true only when each and all targeting attributes are evaluated to be true.

This targeting framework can also be explained using propositional logic. The targeting profile may be expressed as a conjunction (logical AND) of unit targeting profiles, where each unit targeting profile is the specification of one or more targeting attributes. The unit targeting profile is a logical combination of literals, where each literal is either an atomic sentence or a negated atomic sentence. In logic, an atomic sentence is a type of declarative sentence which is either true or false, which may also be referred to as a proposition, statement or truthbearer and which cannot be broken down into other simpler sentences. For example “The dog ran” is an atomic sentence in natural language, whereas “The dog ran and the cat hid” is a molecular sentence in natural language because it contains more than one atomic sentence.

Each atomic sentence is the specification of a targeting type to a specific value meaning that this type includes this value. For example, atomic sentence Tᵢ=Sᵢ₁ means targeting type i may include value Sᵢ₁. The negated atomic sentence indicates that the targeting type should exclude a value, e.g., [symbol] (Tᵢ=Sᵢ₁) means attribute i should not take value Sᵢ₁. The disjunction of the literals specifies the allowed and disallowed values for a targeting type. The conjunction of the disjunctions gives the spectrum of each targeting attribute. The literals indicating allowed values are combined using disjunctions (logical OR), the literals indicating disallowed values are combined using conjunctions (logical AND), and the allowed part and disallowed part are combined using logical AND. The targeting profile can be expression in logical form as following:

TP=G₁ [symbol] G₂ [symbol] . . . [symbol] G_{N}

where

Gᵢ=((Tᵢ=S_{i,1}) [symbol] . . . [symbol] (Tᵢ=S_{i,j})) [symbol] ( [symbol] (Tᵢ=S_{i,j}) [symbol] . . . [symbol] (Tᵢ=S_{i,n})) (1)

is the targeting attribute for the specification of targeting type i.

The commonly-used targeting attributes like age, gender, country, language, time and day and the like can all be expressed as unit target profiles in the form of equation (1). The targeting attribute of segments, also known as conversions, is more complicated as they may include CNF or DNF of the literals or targeting attributes. But again, the targeting segments may include as one unit targeting profile and combined in conjunctive form with other unit targeting profiles.

The following example illustrates these concepts concretely. An automobile company running an online campaign for a new model of pickup truck may specify the following targeting profile. For targeting gender, “male” should be included and “female” should be excluded since males are more likely to drive a pickup truck. For targeting type of age, age between 18 and 65 should be included and others should be excluded considering the user's purchasing power and fitness for pickup trucks. In this case, T_{gender}=(gender=male [symbol] gender=female [symbol] gender=unknown) and T_{age}=((age>18) [symbol] (age<65)). The advertiser is assumed to make no specifications for other targeting attributes. Finally, all targeting attributes are combined using the AND operator, thus the final targeting profile for this automobile manufacturer is T=T_{age} [symbol] T_{gender}.

From the above example, one can see that the current targeting framework in specifying targeting profiles has the following characteristics:

(A) The targeting profile is expressed at the targeting attribute level. Each targeting attribute is expressed first, and then all targeting attributes are logically combined in conjunctive form.

(B) The targeting profile is evaluated at the targeting attribute level. To evaluate if a user profile matches a targeting profile, each targeting attribute is evaluated first. If all targeting attributes are evaluated to be true, then the whole targeting profile is evaluated to be true.

(C) Each targeting attribute is expressed individually and independently. Each literal indicating if a targeting type can or cannot take a value is expressed solely for this targeting type and has no contextual information about the specification of other targeting types.

This simple targeting framework has some limitations. For instance, each targeting attribute is expressed individually and independently without the context information of other targeting attributes. Because the unit targeting profiles are combined conjunctively, a targeting attribute indicating an allowed or a disallowed value for a targeting type has an effective scope of all other targeting attributes, e.g., it is automatically combined conjunctively with all other targeting attributes. Furthermore, it is difficult to apply knowledge from historical data to design targeting profiles. Due to the nature of this simple targeting framework, one can only design the values for each targeting type. Accordingly, the knowledge from correlation analysis between targeting attributes cannot be applied to the targeting profile design.

To expand the expressing power, the disclosed embodiments relate to a system and methods for context-contingent targeting online advertisements. The system may provide an option for an advertiser to express a targeting profile using a freeform (or arbitrary) mixture of logical operations including a plurality of targeting attributes in contrast with being expressed solely as a conjunction of logical formulas. The system may receive the expressed targeting profile from the advertiser and receive an advertising opportunity that substantially matches the targeting profile. The system may then match the advertising opportunity with one or more targeting attributes of the targeting profile. The system may deliver the advertisement associated with the targeting profile that substantially matches the advertising opportunity to a browser of a computing device of a user to fill the advertising opportunity generated by the user.

In the presently-disclosed system, the plurality of targeting attributes may include respective molecular attributes. The logical operations expressed in a freeform style may include a disjunctive of at least some of the plurality of molecular attributes. Each molecular attribute may include a series of literals combined with a logical AND or with a combination of logical operators. Each literal may include an allowed value or a disallowed value. The plurality of molecular attributes may be combined with logical ORs or a mixture of logical ORs and ANDs to make up a targeting profile. The system may tune the targeting profile by adding or deleting one or more of the molecular attributes, providing flexibility in revising the targeting profile to adjust to the most desired targeting results.

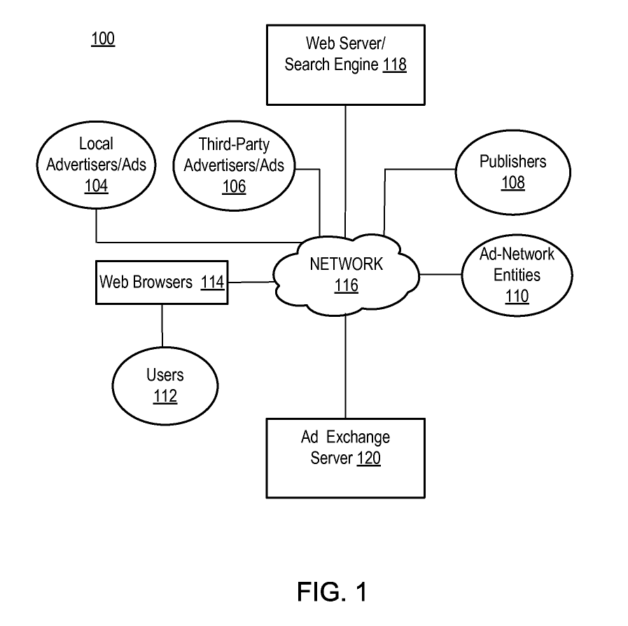

FIG. 1 is a diagram of an exemplary system 100 for executing context-contingent targeting of online advertisements. The system 100 may include a plurality of advertisers 104, third-party advertisers 106, publishers 108, ad-network entities 110, and users 112 that access web pages on publisher websites through web browsers 114 over a communications network 116. The users 112 may access and download web pages on their client computers or other network-capable computing device, such as a desktop, a laptop, or a smart phone (not shown). The communications network 116 may include the Internet or World Wide Web (“Web”), a wide area network (WAN), a local area network (“LAN”), and/or an extranet or other network.

The system 100 may further include a web server 118, which may include a search engine as well as be configured for general delivery of publisher web sites browsed to by the Web users 112. The system may further include one or more ad exchange server 120 such as already briefly discussed, all of which are coupled together, either directly or over the communications network 116. Herein, the phrase “coupled with” includes directly connected to or indirectly connected through one or more intermediate components. The ad exchange server 120 may be integrated within the web server 118 in some embodiments. The ad exchange server 120 receives a request from the web server 118 for ads 104 to be delivered to a search results or other page (not shown) in response to a query submitted by a user 112 or to a browsing or linking action that led the user 112 to download a publisher web page. The request creates an advertisement display opportunity, whether on a search results page or another web page of a publisher website. Accordingly, the web server 118 may host one or more affiliate publishers 108.

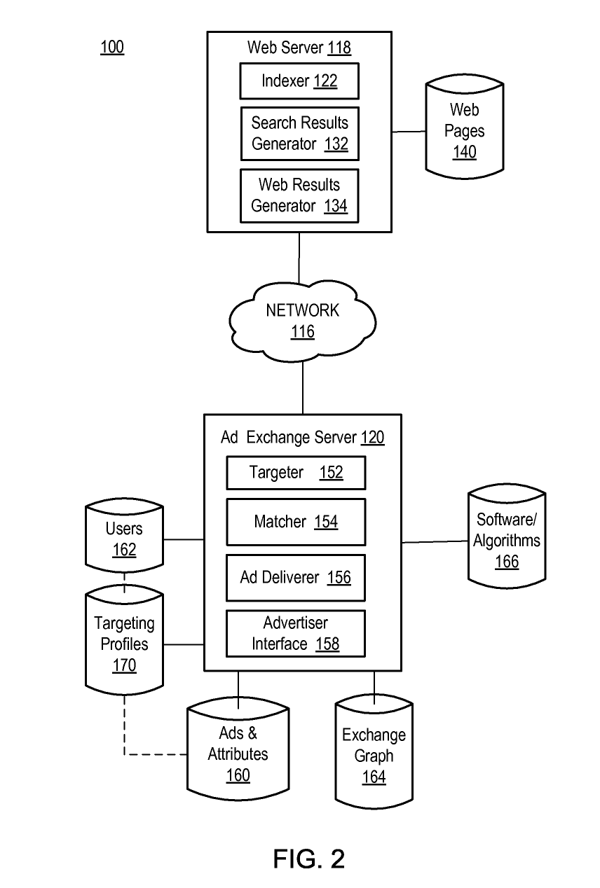

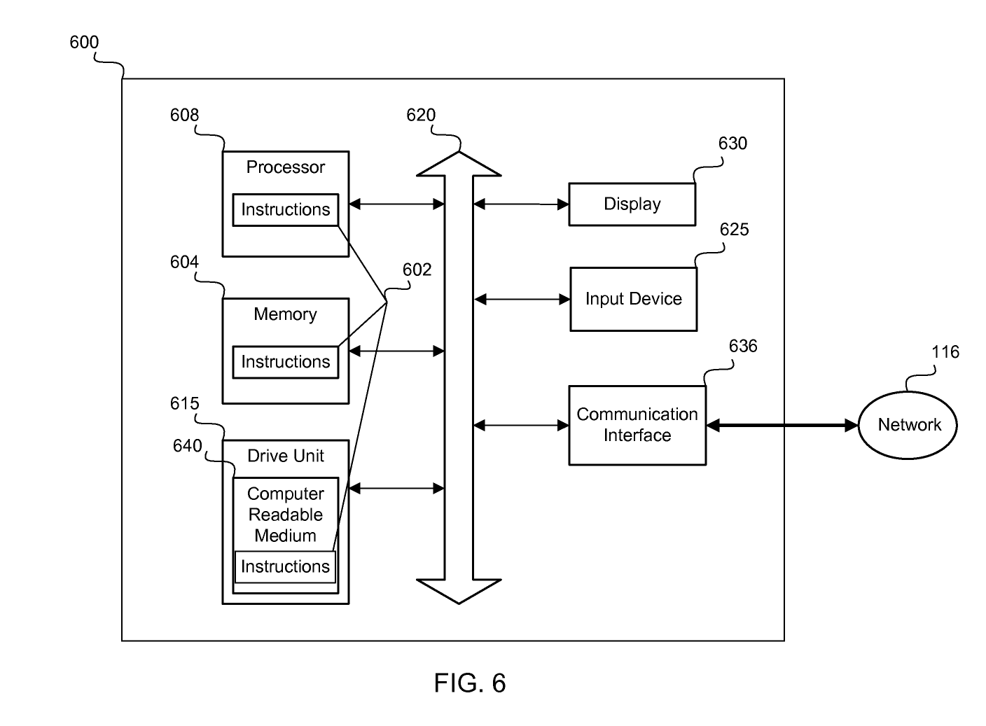

FIG. 2 is a diagram of an exemplary system diagram of architecture of the ad exchange server of FIG. 1. The web server 118 may include an indexer 122, a search results generator 132, and a web results generator 134 and be executable by a processor such as disclosed with reference to FIG. 6. The web server 118 may be coupled with a web pages database 140 stored in computer storage or other memory. The ad exchange server 120 may include a targeter 152, a matcher 154, an ad deliverer 156 and an advertiser (or user) interface 158 all executable by a processor such as disclosed with reference to FIG. 6. The exchange server 120 may further include a number of databases stored in computer storage or other memory, including but not limited to: an ads and attributes database 160, a users database 162, an exchange graph database 164 and a software/algorithms database 166, and a targeting profiles database 170.

The indexer 122 indexes the web pages stored in the web pages database 140 or at disparate locations across the communications network 116 so that a search query executed by a user will return appropriately-relevant search results. When a search is executed, the search results generator 136 generates web results that are as relevant as possible to the search query for display on the search results page. Indeed, organic search results are ranked at least partially according to relevance. Also, when the search query is executed, the web server 118 requests appropriately-relevant ads from the ad exchange server 120 to be served in sponsored ad slots of the search results page.

If a user browses or links to a publisher website, which may be through a search results page, a search engine page, or any other publisher website, the web page generator 134 supplies the web page for download by the user 112 accessing the same. Before supplying the web page, however, the web server 118 requests that the ad exchange server 120 deliver an ad that may be not only relevant to the web page being downloaded, but also that somehow targets the user downloading the web page. This creates an ad display opportunity, which requires that the ad exchange server 120 process the ad exchange graph, which is stored in an ad exchange database 164, to compute bids from advertisers for ads that are valid for the opportunity. The ad exchange server 120 internally runs an auction on behalf of the publisher that supplied the opportunity. Therefore, the publisher 108 is the entity which gets paid, and the auction winner is the candidate advertiser 104 that causes the publisher 108 to be paid the most.

Before the bidding process begins, however, the advertisers develop ads that they want to target to certain types of users or publishers, which are specified using targeting attributes from the ads and attributes database 160. The ad exchange server 120 may, through the advertiser interface 158 of the ad exchange server 120, enable the advertisers 104 or 106 to express what logical combination of targeting attributes each advertiser wants for a specific ad campaign. The propositional logic made available to the advertisers may include a freeform mixture of logical operations, which may include AND, OR, XOR and other Boolean operators known in the art of logic. A logical combination of targeting attributes forms a targeting profile, which may be saved in the targeting profiles database 170 in relation to one or more ads or ad campaigns in the ads and attributes database 160. The dashed line between databases in FIG. 2 indicates that the databases may be integrated or coupled with each other. The attributes may be, at least in part, generated from query logs and browsing histories associated with users in relation to other targeting data, such as demographics, age, gender, geographic location, technographic, and psychographics and the like.

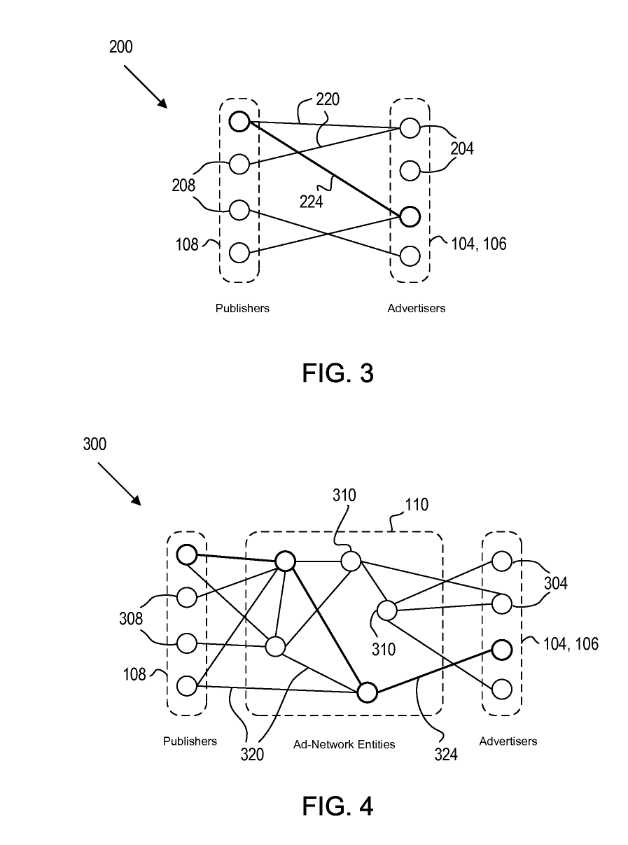

Based on the targeting profiles, algorithms may be generated and software coded that may be executed by the targeter 152 and/or the matcher 154 to target or match an ad opportunity with an ad or ad campaign. The algorithms and software code may be stored in the software and algorithms database 166 of computer storage or memory of the ad exchange server 120 and executed as needed as ad opportunities arise. After a targeting profile is formed, the advertiser is ready to participate in the bidding process to decide what the advertiser is willing to pay for advertising impressions for opportunities meeting the targeting attributes specified in the targeting profile. The ad exchange server 120 may also perform some preliminary filtering to decide whether an ad from an advertiser 104 or 106 is going to be available to participate in the bidding process. This may be necessary by the sure size of an exchange graph as the number of advertisers and publishers grows. This process may be automated by the ad exchange server 120 as it analyzes an exchange graph, a basic overview of which is explained with reference to FIGS. 3 and 4.

FIG. 3 is an exchange graph 200 showing the classic “flat” ad matching problem. A plurality of nodes 208 represents the publishers 108 and a plurality of other nodes 204 represents the advertisers 104 and their ads. A plurality of graph edges 220 represent interconnections directly between advertisers 104 having ads that meet the legality and optimality requirements to fill display opportunities provided by the publishers 108. The ad exchange server 120 finds the optimal and legal path 224 between an opportunity of a publisher 108 and a specific advertisement of an advertiser 104, as discussed above. As discussed, this “flat” ad matching problem is the classic, more simplistic scenario that is relatively easy to solve.

FIG. 4 is an exchange graph 300 showing an ad matching problem that includes intermediate ad-network entities 110. Similar to FIG. 3, the exchange graph of FIG. 4 includes nodes 308 that represent the publishers 108 and nodes 304 that represent the advertisers 104. The added complexity in this exchange graph diagram 300 comes from the addition of nodes 310 that represent intermediate ad-network entities 110. A plurality of graph edges 320 interconnects the nodes 304, 310, 308 of the advertisers 104, the ad-network entities 110, and of the publishers 108, respectively. The ad exchange server 120 finds the optimal and legal path 324 through the exchange graph, which thus meets a plurality of legality predicates, and maximizes payout to the publisher 108 providing an identified display opportunity. Additional information with regards to the bidding and ad selection process with reference to an ad exchange is disclosed in U.S. application Ser. No. 12/749,151, filed Mar. 29, 2010 and entitled “Efficient Ad Selection in Ad Exchange with Intermediaries.” This application is herein incorporated by reference in its entirety.

To expand on the expressing power of the logic in targeting profiles, proposed is to design the targeting profile as an arbitrary logical form (or freeform of logical propositions) instead of a conjunction of targeting attributes. Specifically, the targeting profile is a logical combination of literals where each literal indicates an allowed or disallowed value for a targeting attribute. A typical logical form would be the Disjunctive Normal Form (DNF) where the targeting profile is expressed as a disjunction of conjunctive literals that make up one or more targeting attributes. Due to some advantages of DNF, this disclosure may use this form in examples to illustrate the proposed new targeting framework. However, the proposed framework is not limited to DNF and can be any arbitrary logical combination of the literals or targeting attributes.

The DNF form of a targeting profile may include a number of literals, otherwise known as constraints or predicates, each defining an allowed or disallowed value for a targeting type. Some literals are combined conjunctively across the targeting attributes. Each such conjunction can be considered a molecular targeting profile. The molecular targeting profiles may then be combined disjunctively or with a combination of logical operators. A targeting profile can thus be logically expressed as following:

TP=Q₁ [symbol] Q₂ [symbol] . . . Q_{N}

where

Qᵢ=(Tᵢ₁=S_{i1 j1}) [symbol] (Tᵢ₂=S_{i2 j2}) [symbol] . . . [symbol] (Tᵢ_{ₙ}=Sᵢ_{ₙ}jₙ). (2)

It is evident in this example, which is based on and an example of the proposed new framework, each targeting profile is a disjunction of molecular targeting profiles. If one molecular targeting profile is evaluated to be true, then the whole targeting profile is evaluated to be true. The molecular targeting profile can be seen as one complete targeting profile with specifications for each targeting attribute. The literals, each indicating a specified value for a targeting type, are combined in conjunctive form within the molecular targeting profile. In other words, each literal is contingent on other literals in the molecular targeting profile. Its effective scope is within the molecular targeting profile, and its effectiveness depends on the effectiveness of other literals in the molecular targeting profile. This means that each literal is contingent upon the context of other literals in the molecular targeting profile that indicate the specification of other targeting attributes.

The new targeting framework will be illustrated using the following examples, beginning first with a continuation of the example of pickup truck campaigns. It was assumed earlier that males are more likely to drive a pickup truck. However, it is also known that in some states like Texas, pickup trucks are popular with both males and females. In this case the targeting profile for this campaign would better be expressed as:

T=(geo=TX [symbol] gender=all) [symbol] (geo=others [symbol] gender=male).

With the advent of mobile era, mobile devices will be able to provide more targeting attributes; an important one of such is location which is already provided as a service on mobile devices like the iPhone or iPad made by Apple Inc. of Cupertino, Calif. and on many Android-based devices. Simply adding these new targeting attributes into a targeting profile makes little benefit for advertisers in targeting desired users. The proposed targeting framework, however, can be used to design more delicate and precise targeting. Consider a restaurant on El Camino Real doing an online campaign. A possible targeting profile for its campaign could be expressed as:

T=(geo=within 10 miles of restaurant) [symbol] (hour=4:00-8:00 pm).

In this case, the advertiser wants to target users at dinner time and close to the restaurant. Now suppose this restaurant is in a mall; the advertiser may want to add the targeting to all users in this mall regardless of the time because if the user knows there is such a restaurant around, he or she may take a look, may remember it, and may become a customer any time in the future. The new targeting profile could then be expressed as:

T=(geo=within 10 miles of restaurant) [symbol] (hour=4:00-8:00 pm) [symbol] (location=in the mall).

Note that the targeting profile in the above two examples cannot be expressed using the traditional targeting framework. Besides the expressing power, the new targeting framework also has at least the following advantages:

(A) In the new targeting framework, each literal is context-contingent of other literals in the molecular targeting profile. In other words, a literal, indicating an allowed or disallowed value for a targeting attribute, is evaluated within the context of other targeting attributes in which this literal is effective. Accordingly, the targeting attributes are no longer expressed individually and independently: they are expressed jointly to make a meaningful context. In the above example of a pickup truck campaign, the specifications for targeting attribute “gender” are different under different context of geo locations.

(B) Each molecular targeting profile can be switched on or off easily. To do this, an advertiser can add a switch literal in each molecular targeting profile to switch it on or off. Still better, by enabling or disabling a molecular targeting profile, all other molecular targeting profiles remain unaffected. If one considers each molecular targeting profile as being used to target a section of online users, then the advertiser can “fine-tune” or focus the targeted users by adding or removing some sections of online users. By doing so, the advertiser can analyze the effect of each molecular targeting profile and dynamically adjust the targeting profile, thus to add more-effectively-targeted online users in terms of some performance metric like click-through rate (CTR), post-view conversion (PVC) or post-click conversion (PCC), and to remove less-effectively-targeted online users.

(C) The proposed targeting framework can easily utilize the knowledge of the associations between targeting attributes acquired from analyzing historical data using data mining techniques. A famous case from consumer behavior study is the beer/diaper example that suggested fathers often bought beer at the same time they bought diapers. This information, however, is difficult to target in the traditional targeting framework.

Assume the existing targeting profile for a diaper is:

T=((gender=female) [symbol] (age=18˜45)).

To add the beer/diaper association knowledge into the targeting profile in the old targeting framework, it would be expressed as:

T=((gender=[female,male]) [symbol] (age=18˜45) [symbol] (segment=bought beer)).

It does not make much sense and our knowledge of the association is misused because each targeting attribute is specified independently. The proposed new targeting framework, however, utilizes the association correctly since the specification of each targeting attribute is contingent upon context of other attributes, and the inferred knowledge from data mining can be formed as a molecular targeting profile and then combined with the existing targeting profile, which may be expressed as:

T=((gender=female) [symbol] (age=18˜45)) [symbol] ((gender=male) [symbol] (segment=bought beer)).

Such targeting profiles could be generated based on data mining, and presented to advertisers as recommendations for use with existing advertising campaigns.

The targeting profiles at different levels can be combined easily. Online advertising often has targeting profiles expressed on many levels, for example, on creative level, on line-item level, on campaign level, on publisher level, on network level, etc. Under the proposed targeting framework, the targeting profiles on different levels can be combined conjunctively without much effort.

The new targeting framework can be quickly evaluated using multi-threading or distributed computing. When specified in the DNF form, each molecular targeting profile can be evaluated independently. If one molecular targeting profile is evaluated to be true, the whole targeting profile is evaluated to be true.

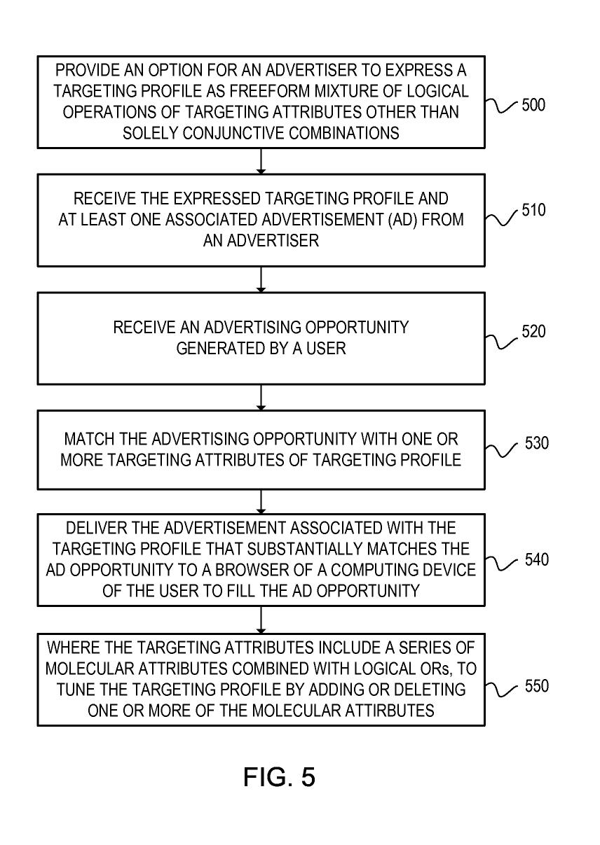

FIG. 5 is a flow chart of an exemplary method for executing context-contingent targeting of online advertising with the system of FIGS. 1 and 2, e.g., through the ad exchange server 120. At block 500, the server 120 may provide, through an advertiser interface of the computer, an option for an advertiser to express a targeting profile using a freeform mixture of logical operations including a plurality of targeting attributes, the freeform mixture of logical operations excluding solely a series of conjunctive combinations. At block 510, the server 120 may receive the expressed targeting profile and at least one associated advertisement from the advertiser. At block 520, the server 120 may receive an advertising opportunity generated by a user. At block 530, the server 120 may match the advertising opportunity with one or more targeting attributes of the targeting profile. And, at lock 540, the server 120 may deliver the advertisement associated with the targeting profile that substantially matches the advertising opportunity to a browser of a computing device of the user to fill the advertising opportunity. Where the plurality of targeting attributes include respective molecular attributes combined with at least some logical ORs, at block 550, the server 120 may tune the targeting profile by adding or deleting one or more of the molecular attributes.

Indexing and querying of complex Boolean expressions has been studied in the research area of database systems and information retrieval. Modern search engines built upon these algorithms, like the Yahoo Research Indexing and Search engine (RISe) built using state-of-the-art technologies of indexing and query of complex Boolean expressions, is available for implementation of the proposed new targeting profiles for an ad exchange system 100. The inventors built a prototype system 100 to validate the new targeting framework using RISe and the targeting profile information in the RightMedia exchange system. In the offline phase, for each advertising campaign, the server 120 retrieves the targeting profile from the database and inserts it as an entry in a query to the RISe search engine. In the online phase, given an ad call, the system 100 builds a query using information from the ad call. This query is sent to the RISe index to be evaluated on all ad campaigns. All the ad campaigns whose targeting profiles match the query were returned in less than 40 ms, which is well within the tolerance of the time-critical ad exchange system 100.

FIG. 6 illustrates a general computer system 600, which may represent the web server 118, which may include a search engine, the ad exchange server 116, or any other computing devices referenced herein or that may be executed by the system 100, such as, for instance, the communications devices of the advertisers 104 and 106 and communication devices of the users 112, whether fixed or mobile. The computer system 600 may include an ordered listing of a set of instructions 602 that may be executed to cause the computer system 600 to perform any one or more of the methods or computer-based functions disclosed herein. The computer system 600 may operate as a stand-alone device or may be connected, e.g., using the network 116, to other computer systems or peripheral devices.

In a networked deployment, the computer system 600 may operate in the capacity of a server or as a client-user computer in a server-client user network environment, or as a peer computer system in a peer-to-peer (or distributed) network environment. The computer system 600 may also be implemented as or incorporated into various devices, such as a personal computer or a mobile computing device capable of executing a set of instructions 602 that specify actions to be taken by that machine, including and not limited to, accessing the Internet or Web through any form of browser. Further, each of the systems described may include any collection of sub-systems that individually or jointly execute a set, or multiple sets, of instructions to perform one or more computer functions.

The computer system 600 may include a memory 604 on a bus 620 for communicating information. Code operable to cause the computer system to perform any of the acts or operations described herein may be stored in the memory 604. The memory 604 may be a random-access memory, read-only memory, programmable memory, hard disk drive or any other type of volatile or non-volatile memory or storage device.

The computer system 600 may include a processor 608, such as a central processing unit (CPU) and/or a graphics processing unit (GPU). The processor 508 may include one or more general processors, digital signal processors, application specific integrated circuits, field programmable gate arrays, digital circuits, optical circuits, analog circuits, combinations thereof, or other now known or later-developed devices for analyzing and processing data. The processor 608 may implement the set of instructions 602 or other software program, such as manually-programmed or computer-generated code for implementing logical functions. The logical function or any system element described may, among other functions, process and/or convert an analog data source such as an analog electrical, audio, or video signal, or a combination thereof, to a digital data source for audio-visual purposes or other digital processing purposes such as for compatibility for computer processing.

The computer system 600 may also include a disk or optical drive unit 615. The disk drive unit 615 may include a computer-readable medium 640 in which one or more sets of instructions 602, e.g., software, can be embedded. Further, the instructions 602 may perform one or more of the operations as described herein. The instructions 602 may reside completely, or at least partially, within the memory 604 and/or within the processor 608 during execution by the computer system 600. Accordingly, the databases 140, 160, 162, 164, 166 and 170 described above in FIG. 2 may be stored in the memory 604 and/or the disk unit 615.

The memory 604 and the processor 608 also may include computer-readable media as discussed above. A “computer-readable medium,” “computer-readable storage medium,” “machine readable medium,” “propagated-signal medium,” and/or “signal-bearing medium” may include any device that includes, stores, communicates, propagates, or transports software for use by or in connection with an instruction executable system, apparatus, or device. The machine-readable medium may selectively be, but not limited to, an electronic, magnetic, optical, electromagnetic, infrared, or semiconductor system, apparatus, device, or propagation medium.

Additionally, the computer system 600 may include an input device 625, such as a keyboard or mouse, configured for a user to interact with any of the components of system 600. It may further include a display 670, such as a liquid crystal display (LCD), a cathode ray tube (CRT), or any other display suitable for conveying information. The display 670 may act as an interface for the user to see the functioning of the processor 608, or specifically as an interface with the software stored in the memory 604 or the drive unit 615.

The computer system 600 may include a communication interface 636 that enables communications via the communications network 116. The network 116 may include wired networks, wireless networks, or combinations thereof. The communication interface 636 network may enable communications via any number of communication standards, such as 802.11, 802.17, 802.20, WiMax, 802.15.4, cellular telephone standards, or other communication standards.

Accordingly, the method and system may be realized in hardware, software, or a combination of hardware and software. The method and system may be realized in a centralized fashion in at least one computer system or in a distributed fashion where different elements are spread across several interconnected computer systems. Any kind of computer system or other apparatus adapted for carrying out the methods described herein is suited. A typical combination of hardware and software may be a general-purpose computer system with a computer program that, when being loaded and executed, controls the computer system such that it carries out the methods described herein. Such a programmed computer may be considered a special-purpose computer.

The method and system may also be embedded in a computer program product, which includes all the features enabling the implementation of the operations described herein and which, when loaded in a computer system, is able to carry out these operations. Computer program in the present context means any expression, in any language, code or notation, of a set of instructions intended to cause a system having an information processing capability to perform a particular function, either directly or after either or both of the following: a) conversion to another language, code or notation; b) reproduction in a different material form.

As discussed above, the system serves advertisements and interfaces that convey additional information related to the advertisement. For example, the system generates browser code operable by a browser to cause the browser to display a web page of information that includes an advertisement. The advertisement may include a graphical indicator that indicates that the advertisement is associated with an interface that conveys additional information associated with the advertisement. The browser code is operable to cause the browser to detect a selection of the graphical indicator, and display the interface along with the information displayed on the web page in response to the selection of the graphical indicator. The advertisement and the additional information conveyed via the interface are submitted by an advertiser during an advertisement submission time.

The above-disclosed subject matter is to be considered illustrative, and not restrictive, and the appended claims are intended to cover all such modifications, enhancements, and other embodiments, which fall within the true spirit and scope of the present disclosure. Thus, to the maximum extent allowed by law, the scope of the present embodiments are to be determined by the broadest permissible interpretation of the following claims and their equivalents, and shall not be restricted or limited by the foregoing detailed description. While various embodiments have been described, it will be apparent to those of ordinary skill in the art that many more embodiments and implementations are possible within the scope of the above detailed description. Accordingly, the embodiments are not to be restricted except in light of the attached claims and their equivalents.

1. A computer-implemented method for context-contingent targeting of online advertisements, the method executable by a computer having a processor and memory, comprising:
providing, by the processor through an advertiser interface of the computer, an option for an advertiser to express a targeting profile using a freeform mixture of logical operations comprising a plurality of targeting attributes, the freeform mixture of logical operations excluding solely a series of conjunctive combinations;
receiving, with the computer, the expressed targeting profile and at least one associated advertisement from the advertiser;
receiving, with the computer, an advertising opportunity generated by a user;
matching, by the processor, the advertising opportunity with one or more targeting attributes of the targeting profile; and
delivering, with the computer, the advertisement associated with the targeting profile that substantially matches the advertising opportunity to a browser of a computing device of the user to fill the advertising opportunity.

2. The method of claim 1, where the plurality of targeting attributes comprise respective molecular attributes, and where the logical operations comprise a disjunctive of at least some the plurality of molecular attributes.

3. The method of claim 2, where each molecular attribute comprises a series of literals combined with a logical AND or with a combination of logical operators.

4. The method of claim 3, where the literals comprise an allowed value or a disallowed value.

5. The method of claim 2, where the plurality of molecular attributes are combined at least in part with logical ORs, the method further comprising:
tuning the targeting profile by adding or deleting one or more of the molecular attributes.

6. The method of claim 1, where the logical operations comprise a disjunctive of the plurality of attributes including a disjunctive normal form where the targeting profile comprises a disjunctive of conjunctive targeting attributes.

7. The method of claim 6, where the attributes comprise constraints including an allowed or a disallowed value, the method further comprising:
tuning the targeting profile by adding or deleting the targeting attributes.

8. The method of claim 1, where matching comprises searching through an indexed database of targeting profiles saved in the memory in relation to associated advertisements.

9. An advertising exchange server for context-contingent targeting of online advertisements, comprising:
a processor and memory;
a communication interface coupled with the processor;
a database saved in system storage coupled with the processor, the database configured to store advertisements saved in relation to advertising attributes;
where the processor, in conjunction with the communication interface, is configured to:
provide an option for an advertiser to express a targeting profile using a freeform mixture of logical operations comprising a plurality of targeting attributes, the freeform mixture of logical operations excluding solely a series of conjunctive combinations;
receive, and store in memory, the expressed targeting profile and at least one associated advertisement from the advertiser;
receive and match an advertising opportunity with one or more targeting attributes of the targeting profile; and
deliver the advertisement associated with the targeting profile that substantially matches the advertising opportunity to fill the advertising opportunity.

10. The server of claim 9, where the plurality of targeting attributes comprise respective molecular attributes, and where the logical operations comprise a disjunctive of at least some the plurality of molecular attributes.

11. The server of claim 10, where each molecular attribute comprises a series of literals combined with a logical AND or with a combination of logical operators.

12. The server of claim 11, where the literals comprise an allowed value or a disallowed value.

13. The server of claim 10, where the plurality of molecular attributes are combined at least in part with logical ORs, the method further comprising:
tuning the targeting profile by adding or deleting one or more of the molecular attributes.

14. The server of claim 9, where the logical operations comprise a disjunctive of the plurality of attributes including a disjunctive normal form where the targeting profile comprises a disjunctive of conjunctive targeting attributes.

15. The server of claim 14, where the attributes comprise constraints including an allowed or a disallowed value, the processor further configured to tune the targeting profile by adding or deleting the targeting attributes.

16. A computer-readable medium comprising a set of instructions for context-contingent targeting of online advertisements, the set of instructions executable by a computing device having a processor and memory, the computer-readable medium comprising:
instructions to direct the processor to provide an option for an advertiser to express a targeting profile using a freeform mixture of logical operations comprising a plurality of targeting attributes, the freeform mixture of logical operations excluding solely a series of conjunctive combinations;
instructions to direct the processor to receive the expressed targeting profile and at least one associated advertisement from the advertiser;
instructions to direct the processor to receive an advertising opportunity generated by a user;
instructions to direct the processor to match the advertising opportunity with one or more targeting attributes of the targeting profile; and
instructions to direct the processor to deliver the advertisement associated with the targeting profile that substantially matches the advertising opportunity to a browser of a computing device of the user to fill the advertising opportunity.

17. The computer-readable medium of claim 16, where the plurality of targeting attributes comprise respective molecular attributes, and where the logical operations comprise a disjunctive of at least some the plurality of molecular attributes.

18. The computer-readable medium of claim 17, where each molecular attributes comprises a series of literals combined with a logical AND or with a combination of logical operators.

19. The computer-readable medium of claim 18, where the literals comprise an allowed value or a disallowed value.

20. The computer-readable medium of claim 17, where the plurality of molecular attributes are combined at least in part with logical ORs, the instructions further to direct the processor to tune the targeting profile by adding or deleting one or more of the molecular attributes.

21. A system including a user interface for enabling context-contingent targeting of online advertisements, comprising:
a processor and memory;
a user interface executable by the processor within a browser of a computing device of an advertiser, the user interface configured to receive an input from the browser including a freeform mixture of logical operations defining a targeting profile, the targeting profile comprising a plurality of targeting attributes excluding solely a series of conjunctive combinations of the plurality of targeting attributes; and
a database saved in the memory, the database configured to store advertisements saved in relation to advertising attributes of the targeting profile to be matched with online advertising opportunities.

22. The system of claim 21, the processor further configured to
match the targeting profile with at least one of a plurality of online advertising opportunities generated by a plurality of users; and
in response to finding a match, delivering the matching advertisement to fill the at least one online advertising opportunity.

23. The system of claim 21, where the plurality of targeting attributes comprise respective molecular attributes, and where the logical operations comprise a disjunctive of at least some the plurality of molecular attributes.

24. The system of claim 23, where each molecular attribute comprises a series of literals combined with a logical AND or with a combination of logical operators, where the literals comprise an allowed value or a disallowed value.

25. The system of claim 23, where the plurality of molecular attributes are combined at least in part with logical ORs, the processor further configured to tune the targeting profile by adding or deleting one or more of the molecular attributes in response to inputs through the user interface to delete the one or more molecular attributes.

26. A computer-implemented method for context-contingent targeting of online advertisements, the method executable by a computer having a processor and memory, comprising:
receiving, by the computer, an advertising opportunity generated by a user;
matching, by the processor, the advertising opportunity with a targeting profile saved in the memory, the targeting profile comprising a plurality of targeting attributes expressed in a freeform mixture of logical operations excluding solely a series of conjunctive combinations of the plurality of targeting attributes;
retrieving, by the processor, an advertisement saved in memory in relation to the targeting profile having targeting attributes substantially matching attributes of the advertising opportunity; and
delivering, by the computer, the advertisement to a browser of the user to fill the advertisement opportunity.

27. The method of claim 26, where the plurality of targeting attributes comprise respective molecular attributes, and where the logical operations comprise a disjunctive of at least some the plurality of molecular attributes.

28. The method of claim 27, where each molecular attributes comprises a series of literals combined with a logical AND or with a combination of logical operators, where the literals comprise an allowed value or a disallowed value.

29. The method of claim 27, where the plurality of molecular attributes are combined at least in part with logical ORs, the method further comprising:
receiving a revision to the targeting profile as an addition or deletion of one or more of the molecular attributes.

30. The method of claim 26, where the logical operations comprise a disjunctive of the plurality of targeting attributes including a disjunctive normal form, where the targeting profile comprises a disjunctive of conjunctive targeting attributes, and where the targeting attributes comprise literals including an allowed or a disallowed value, the method further comprising:
receiving a revision to the targeting profile as an addition or a deletion of one or more of the targeting attributes.
